(19) United States
(12) Patent Application Publication
(10) Pub. No.: US 2022/0026907 A1
(43) Pub. Date: Jan. 27, 2022

(54) METHOD AND SYSTEM FOR AUTOMATICALLY TRACKING AND PHOTOGRAPHING

(71) Applicant: REMO TECH Co., Ltd., Shenzhen (CN)

(72) Inventors: Yu Peng, Shenzhen (CN); Ming Zhang, Shenzhen (CN); Long Huang, Shenzhen (CN)

(21) Appl. No.: 17/499,903

(22) Filed: Oct. 13, 2021

Related U.S. Application Data
(63) Continuation of application No. PCT/CN2019/101268, filed on Aug. 19, 2019.

(30) Foreign Application Priority Data
Aug. 2, 2019 (CN) 201910713790.0

(51) Int. Cl. G05D 1/00; H04N 5/232; G03B 17/56; G01C 11/02; G05B 6/02; F16M 11/12

(52) U.S. Cl. CPC G05D 1/0094; H04N 5/23299; F16M 11/123; G01C 11/02; G05B 6/02; G03B 17/561

(57) ABSTRACT

Disclosed are a method and system for automatically tracking and photographing. The method includes: obtaining a yaw axis gimbal angle parameter and processing an image captured by a camera to obtain a distance parameter; calculating a steering gear rotation angle control parameter according to the yaw axis gimbal angle parameter and calculating a motor speed control parameter according to the distance parameter; controlling the rotation of a gimbal of a gimbal camera according to the yaw axis gimbal angle parameter to control the rotation of the camera, and controlling the rotation of a steering gear installed in a photographing-moving apparatus for placing the gimbal camera according to the steering gear rotation angle control parameter, so that the photographing-moving apparatus faces a target, while controlling the rotation speed of a motor installed in the photographing-moving apparatus according to motor speed control parameter to achieve tracking the target.

### CROSS-REFERENCE TO RELATED APPLICATION

The present application is a Continuation Application of PCT Application No. PCT/CN2019/101268 filed on Aug. 19, 2019, which is based on Chinese patent application No. 201910713790.0 filed on Aug. 2, 2019, and claims its priority. The entire disclosure of the application is incorporated herein by reference in its entirety.

### FIELD OF THE INVENTION

This disclosure relates to the field of artificial intelligence technology, and in particular to a method and a system for automatically tracking and photographing.

### BACKGROUND OF THE INVENTION

With the popularization of smart devices, consumers and users are using various smart electronic devices more frequently and enthusiastically. Among the popular functions of the smart devices, photographing and video-recording are used most often by users.

In the prior art, when people create video materials with more agile targets and more flexible scene switching, the method used is nothing more than manual tracking photography, remote-controlled drone aerial photography, or tracking photography by a handheld camera plus a stabilizer. However, the tracking photography by the handheld camera plus the stabilizer requires the photographer to invest more efforts to follow a target and hold the camera steadily to track the target, and thus it is very laborious, and the remote-controlled drone aerial photography has the disadvantages of insufficient tracking strength, insufficient targeted video shooting function, and a short battery life. Moreover, these two tracking photography methods require two or more tracking photographers which do not conform to the original intention of fully intelligent automation.

### SUMMARY OF THE INVENTION

Therefore, it is a primary objective of the present invention to provide a method and system for automatically tracking and photographing, so as to achieve an automatic orientation and follow a shooting target.

In a first aspect, an embodiment of this disclosure provides a method for automatically tracking and photographing, and the method comprises: obtaining a yaw axis gimbal angle parameter and processing an image captured by a camera to obtain a distance parameter; calculating and obtaining a steering gear rotation angle control parameter according to the yaw axis gimbal angle parameter and calculating and obtaining a motor speed control parameter according to the distance parameter; controlling the rotation of a gimbal of a gimbal camera according to the yaw axis gimbal angle parameter, so as to control the turning of the camera, and controlling the rotation of a steering gear placed in a photographing-moving apparatus of the gimbal camera steering gear according to the steering gear rotation angle control parameter, so that the photographing-moving apparatus faces a target, while controlling the rotation speed of the motor in the photographing-moving apparatus according to the motor speed control parameter to realize the tracking of a target.

In a second aspect, an embodiment of this disclosure further provides a system for automatically tracking and photographing, and the system comprises a gimbal camera and a photographing-moving apparatus, and the gimbal camera has a gimbal, and a camera and a controller installed on the gimbal. The gimbal is provided for adjusting a lens rotation angle of the camera, and the photographing-moving apparatus is provided for placing the gimbal camera, and the photographing-moving apparatus has a steering gear installed on the photographing-moving apparatus for controlling the heading direction of the photographing-moving apparatus, and a motor for controlling the operating speed of the photographing-moving apparatus. Wherein, the controller comprises a first acquiring unit for obtaining a yaw axis gimbal angle parameter, and processing an image captured by the camera to obtain a distance parameter; a processing unit, for calculating and obtaining a steering gear rotation angle control parameter according to the yaw axis gimbal angle parameter, and calculating and obtaining a motor speed control parameter according to the distance parameter; a control adjusting unit, for controlling the rotation of a gimbal of the gimbal camera according to the yaw axis gimbal angle parameter to control the rotation of the camera and controlling the rotation of a steering gear installed in the photographing-moving apparatus according to the steering gear rotation angle control parameter, so that the photographing-moving apparatus faces a target, while controlling the rotation speed of the motor installed in the photographing-moving apparatus according to the motor speed control parameter to realize target tracking.

Compared with the prior art, this disclosure uses the photographing-moving apparatus to carry the gimbal camera which obtains the yaw axis gimbal angle parameter and processes the image captured by the camera to obtain the distance parameter, and controls the rotation of the gimbal according to the yaw axis gimbal angle parameter to adjust the rotation angle of the camera, and calculates and obtains a steering gear rotation angle control parameter and a motor speed control parameter according to the yaw axis gimbal angle parameter and the distance parameter respectively to control the motor rotation speed of the photographing-moving apparatus according to the motor speed control parameter while controlling the rotation of the steering gear installed in the photographing-moving apparatus according to the steering gear rotation angle control parameter to make the rotation angle of the steering gear the same as the lens rotation angle, so that the photographing-moving apparatus always faces the target to realize direction tracking. Further, this disclosure uses the adjustment of the lens rotation angle of the camera to ensure the shooting effect of the tracked target and uses the photographing-moving apparatus to carry out both distance tracking and direction tracking, so as to achieve the effect of always following the moving target.

### BRIEF DESCRIPTION OF THE DRAWINGS

FIG. 1 is a perspective view of a system for automatically tracking and photographing in accordance with an embodiment of this disclosure;

FIG. 2 is a schematic block diagram of a system for automatically tracking and photographing in accordance with an embodiment of this disclosure;

FIG. 3 is a schematic block diagram of a controller installed in a system for automatically tracking and photographing in accordance with an embodiment of this disclosure;

FIG. 4 is a schematic block diagram of a controller installed in a system for automatically tracking and photographing in accordance with another embodiment of this disclosure;

FIG. 5 is a flowchart of a method for automatically tracking and photographing in accordance with an embodiment of this disclosure;

FIG. 6 is a flowchart showing a sub process of a system for automatically tracking and photographing in accordance with an embodiment of this disclosure; and

FIG. 7 is a flowchart of a method for automatically tracking and photographing in accordance with another embodiment of this disclosure.

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

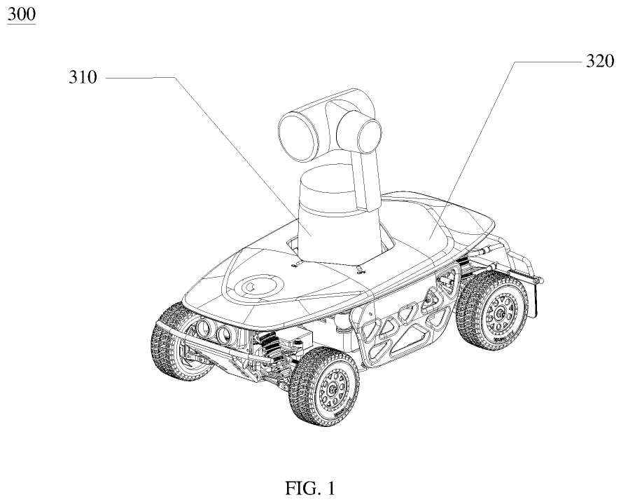

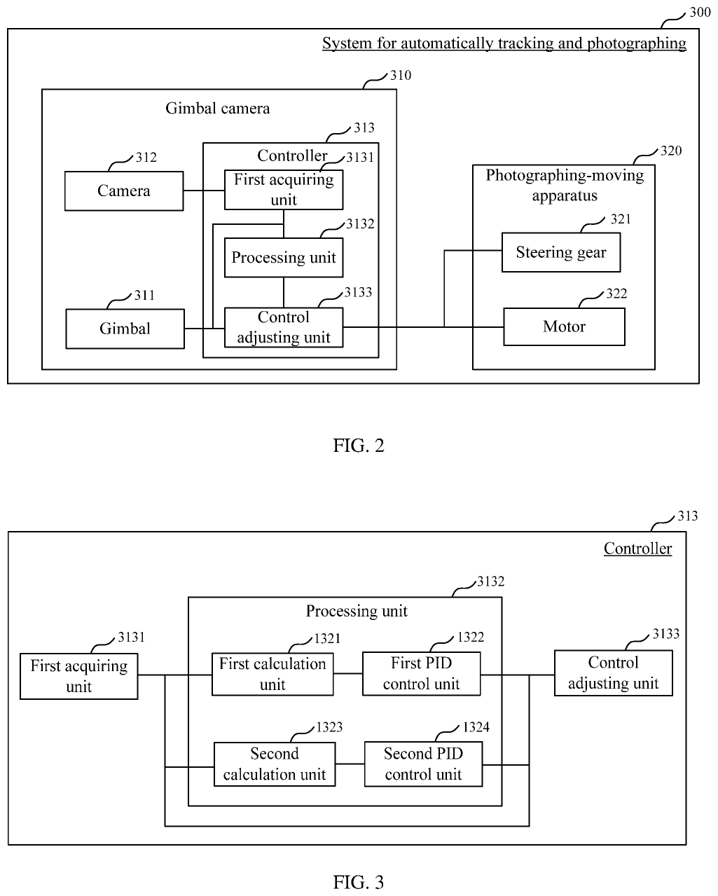

Referring to FIGS. 1 and 2 for the perspective view and the schematic block diagram of a system for automatically tracking and photographing 300 in accordance with an embodiment of this disclosure respectively, the system for automatically tracking and photographing 300 comprises a gimbal camera 310 and a photographing-moving apparatus 320, and the gimbal camera 310 comprises a gimbal 311, and a camera 312 and a controller 313 installed on the gimbal 311. In this disclosure, the camera 312 is mounted onto the gimbal 311, and can be turned on to perform imaging or video recording a target. Wherein, the gimbal 311 is a conventional three-axis gimbal capable of driving the camera 312 to rotate in different directions and realize an all-round angle adjustment. In this disclosure, the controller 313 is an ARM-M3/M4 cortex MCU, such as the STM32 series, GD32 series or a 32-bit microcontroller chip of any other platform. Preferably, the microcontroller chip with the model number GD32F330 is used as the controller 313 in this embodiment, and the controller 313 comprises a first acquiring unit 3131, a processing unit 3132 and a control adjusting unit 3133, wherein the first acquiring unit 3131, the processing unit 3132 and the control adjusting unit 3133 are program modules executed by the microcontroller chip with the model number of GD32F330; the photographing-moving apparatus 320 provided for placing gimbal camera 310, the photographing-moving apparatus 320 has a steering gear 321 installed thereon for controlling the heading direction of the photographing-moving apparatus 320 and a for controlling the operating speed of a motor 322 of the photographing-moving apparatus 320. Understandably, the steering gear 321 is designed with a yaw axis (steering axis) angle control loop for controlling the steering. Preferably, in this embodiment, the photographing-moving apparatus 320 is a robotic car having a suspension type shock absorber structure installed to a chassis of the robotic car and a placement platform provided for placing the gimbal camera 310 and designed with a secondary shock absorption structure, and the motor 322 is a high-speed brushless DC motor.

In this embodiment, the first acquiring unit 3131 is provided for obtaining a yaw axis gimbal angle parameter and processing an image captured by the camera 312 to obtain a distance parameter. In this disclosure, the first acquiring unit 3131 directly obtains the yaw axis gimbal angle parameter based on a deep neural network and the distance between the target obtained from the image and the camera 312 (which is the distance parameter) based on the deep neural network, and such technologies are technical means commonly used by those skilled in the art, and thus will not be repeated. The processing unit 3132 is provided for calculating and obtaining a steering gear rotation angle control parameter according to the yaw axis gimbal angle parameter, and calculating and obtaining a motor speed control parameter according to the distance parameter. The control adjusting unit 3133 is provided for controlling the rotation of the gimbal 311 the gimbal camera 310 according to the yaw axis gimbal angle parameter in order to control the rotation of the camera 312, and controlling the rotation of the steering gear 321 installed in the photographing-moving apparatus 320 according to the steering gear rotation angle control parameter, so that the photographing-moving apparatus 320 faces the target, while controlling the rotation speed of the motor 322 installed in the photographing-moving apparatus 320 according to the motor speed control parameter to achieve target tracking. Understandably, the control adjusting unit 3133 transmits a control signal to the gimbal 311, the steering gear 321 and the motor 322, and the transmitted control signal can be filtered, amplified and processed, and then driven by the gimbal 311, the steering gear 321 and a drive circuit in the motor 322 to drive the gimbal 311, the steering gear 321 and the motor 322 to work. In this disclosure, if the target is situated in a moving status and its position keeps changing, the control adjusting unit 3133 will control the yaw axis of the three-axis gimbal installed in the gimbal camera 310 to rotate towards the moving direction of the target according to the yaw axis gimbal angle parameter, so as to drive the rotation of the camera 312, while controlling the steering gear 321 of the robotic car turns in the same direction with the rotation of the camera 312 according to steering gear rotation angle control parameter to fine-tune the steering, until the rotation of the camera 312 resumes its original position, so that the front of the car always faces the target to achieve the direction tracking effect. In the meantime, the control adjusting unit 3133 controls the rotation speed of the motor 322 of the robotic car according to the motor speed control parameter to achieve the distance tracking effect. Therefore, the camera 312 of the system for automatically tracking and photographing 300 in accordance with this disclosure can follow the rotation of the target rotation to ensure that the target always falls within the range of the lens, and the photographing-moving apparatus 320 can track and following the free moving target.

In some embodiments as shown in FIG. 3, the processing unit 3132 comprises a first calculation unit 1321, a first PID control unit 1322, a second calculation unit 1323 and a second PID control unit 1324.

Specifically, the first calculation unit 1321 is provided for calculating an angle deviation of the yaw axis gimbal angle parameter from a predetermined angle parameter, wherein the predetermined angle parameter is 0°. In this embodiment, the angle deviation of the yaw axis gimbal angle parameter from the predetermined angle parameter is the difference between the actual sampled value (the angle of lens relative to the positive direction, which is the angle of the yaw axis of the three-axis gimbal relative to the positive direction) and the predetermined angle value. The first PID control unit 1322 is provided for calculating and obtaining a steering gear rotation angle control parameter according to the angle deviation by using the PID algorithm, and the equation of the Proportional-Integral-Derivative (PID) control algorithm) is: u=Kₚ×error+Kᵢ×∫error+K_{d}×d(error)/dt, wherein error is the above obtained angle deviation, Kₚ, Kᵢ, and K_{d} are the coefficients of the proportional term, the integral term, the differential term in the PID algorithm respectively, which are all constants. The second calculation unit 1323 is provided for calculating a distance deviation of the distance parameter from a first predetermined distance. In this disclosure, the distance deviation is the difference between the actual distance value (which is the distance of the camera 312 relative to the target) and the first predetermined distance. Preferably, the first predetermined distance is set to 2 m to obtain a better shooting effect, and it can be set according to actual needs in some other embodiments. The second PID control unit 1324 is provided for calculating and obtaining a motor speed control parameter according to the distance deviation by using the PID algorithm. Understandably, when the PID algorithm is used to obtain the motor speed control parameter according to the distance deviation, the distance deviation is the error in the equation of the PID algorithm.

In summation of the description above, the system for automatically tracking and photographing 300 of this disclosure uses the robotic car to carry the gimbal camera 310. If the tracked target is moving sideways, then the yaw axis of the three-axis gimbal of the gimbal camera 310 will rotate towards the target moving direction to drive and rotate the camera 312, so as to ensure that the shooting effect of the tracked target while using the PID algorithm to carry out the steering control of the yaw axis of the steering gear 321 and the speed control of the motor 322, so as to achieve the distance control and the direction control simultaneously and keep tracking and following the target which is moving freely. The secondary shock absorption structure used by the robotic car can make the video shot more stable; the high-rotation-speed brushless DC motor can satisfy the shooting requirements for the high-speed moving target; and the steering gear can respond quickly without losing track of the target direction in sudden changes.

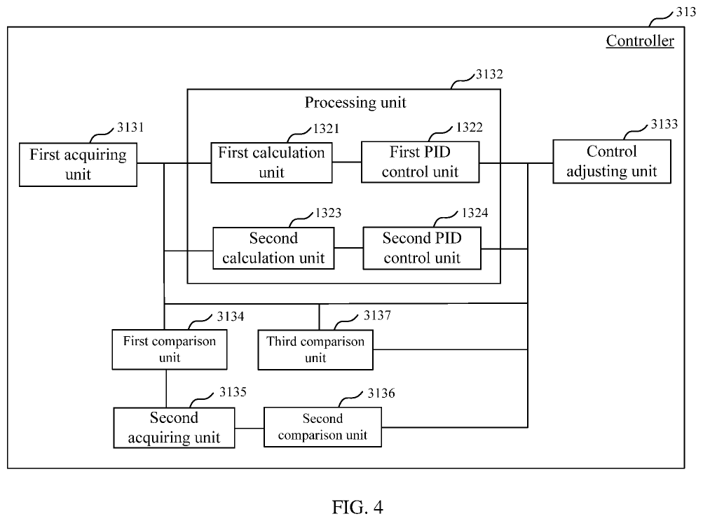

Referring to FIG. 4 for the schematic block diagram of a controller 313 of the system for automatically tracking and photographing 300 in accordance with another embodiment of this disclosure, the system for automatically tracking and photographing 300 of this embodiment adds a first comparison unit 3134, a second acquiring unit 3135, a second comparison unit 3136 and a third comparison unit 3137 to the controller 313.

Specifically, the first comparison unit 3134 is provided for comparing the distance parameter with the second predetermined distance; the second acquiring unit 3135 is provided for obtaining the rotation speed of the motor 322 of the photographing-moving apparatus 320 if the distance parameter is smaller than or equal to the second predetermined distance; the second comparison unit 3136 is provided for comparing the obtained rotation speed of the motor 322 with the first predetermined rotation speed; and the control adjusting unit 3133 is provided for controlling the motor 322 to stop its rotation if the obtained rotation speed of the motor 322 is smaller than or equal to the first predetermined rotation speed. In this disclosure, if the distance parameter is smaller than a predetermined distance, and the very small difference of the integral effect in the PID modulator will be amplified gradually with time, so that the robotic car moves forward and backward repeatedly, fluctuating around this predetermined distance value. In this embodiment, a specific control window is set to realize the safe and reliable start and stop of the robotic car. In other words, if the distance parameter is smaller than or equal to the second predetermined distance (such as 1 m), the speed of the robotic car at that moment is detected. If the current speed of the robotic car is very slow (that is, the rotation speed of the motor 322 of the robotic car is smaller than or equal to the first predetermined rotation speed), the speed of the robotic car will be set to 0, and if the stop position of the robotic car falls within the range of the predetermined distance value, the robotic car will remain still to reach a stably stopped status.

The third comparison unit 3137 is provided for comparing the distance parameter with the second predetermined distance, the third predetermined distance and the fourth predetermined distance. The control adjusting unit 3133 is provided for controlling the rotation speed of the motor 322 of the photographing-moving apparatus 320 to be not greater than the second predetermined rotation speed if the distance parameter is greater than the second predetermined distance and smaller than or equal to the third predetermined distance, and controlling the rotation speed of the motor 322 of the photographing-moving apparatus 320 to be not greater than the third predetermined rotation speed if the distance parameter is greater than the third predetermined distance and smaller than or equal to the fourth predetermined distance. In other words, the maximum rotation speed of the motor 322 of the robotic car is set to be the second predetermined rotation speed when the distance parameter falls between the second predetermined distance and the third predetermined distance; and the maximum rotation speed of the motor 322 of the robotic car is set to be the third predetermined rotation speed when the distance parameter falls between the third predetermined distance and the fourth predetermined distance, the second predetermined rotation speed is smaller than the third predetermined rotation speed. Understandably, a maximum speed is set with different levels according to different distances between the camera 312 and the target in this embodiment, in order to avoid the robotic car from keeping moving when the target suddenly stops during the moving process. In other words, if the distance parameter falls within a certain distance interval, the maximum rotation speed is the maximum speed limit corresponding to the current distance interval. In the actual implementation, the greater the distance between the target and the camera 312, the greater the maximum speed of the robotic car. For example, if the distance between the target and the camera 312 falls within range between the second predetermined distance and the third predetermined distance (such as a range of 1-2 m), the robotic car will be allowed to have a maximum speed of 10 km/h; and if the distance parameter falls within a range between the third predetermined distance and the fourth predetermined distance (such as a range of 2-2.5 m), then the robotic car is allowed to have a maximum speed of 15 km/h. In this way, several distance ranges are divided to prevent the robotic car from being too close to the target or colliding with the target in a sudden stop due to the insufficient braking distance. In this disclosure, if the distance parameter is greater than the fourth predetermined distance, the robotic car will not collide with the target due to insufficient braking distance, and the system 300 does not have any maximum speed limit of the corresponding class for controlling the operation. In other words, if the distance between the target and the camera 312 is greater than the fourth predetermined distance, the maximum speed of the distance interval class will not be limited. Understandably, the robotic car has an overall maximum speed due to the internal hardware limitation. When the distance parameter is greater than the fourth predetermined distance, although no maximum speed is set in the system 300 in this distance interval, the speed of the robotic car still cannot exceed its overall maximum speed.

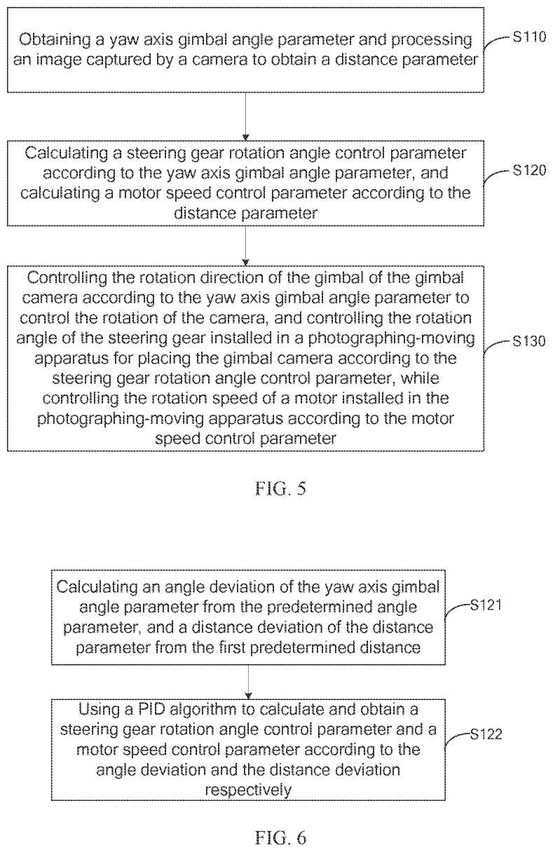

Referring to FIG. 5 for the flowchart of a method for automatically tracking and photographing in accordance with an embodiment of this disclosure, the method comprises the following steps S110-S130:

S110: Obtaining a yaw axis gimbal angle parameter, and process an image captured by a camera to obtain a distance parameter.

In this disclosure, the yaw axis gimbal angle parameter can be obtained directly from the image based on the deep neural network, wherein the yaw axis gimbal angle parameter is provided for controlling the rotation of the gimbal camera, so that the lens of the camera faces the target. Similarly, the image captured by the camera can be processed to obtain the distance between the target and camera based on the deep neural network, wherein the distance is the distance parameter.

In this embodiment, the gimbal camera comprises a gimbal and a camera installed onto the gimbal (that is, the camera is mounted onto the gimbal). The camera can be turned on to carry out the imaging or video recording of the target. The gimbal of this disclosure is a conventional three-axis gimbal capable of driving the camera to rotate in different directions and realize an all-round angle adjustment, and the camera is also a common camera used by those skilled in the art, thus their description will not be repeated herein. In this embodiment, the gimbal camera is placed on the photographing-moving apparatus, and the photographing-moving apparatus is a robotic car, and the gimbal camera is driven to track and shoot the target, and a steering gear and a motor are installed to the photographing-moving apparatus.

S120: Calculating a steering gear rotation angle control parameter according to the yaw axis gimbal angle parameter, and calculating a motor speed control parameter according to the distance parameter.

In this disclosure, the motor speed control parameter is used for controlling the rotation speed of the motor installed in the photographing-moving apparatus, and the steering gear rotation angle control parameter is used for controlling the steering of the steering gear installed in the photographing-moving apparatus.

Specifically, in some embodiments as shown in FIG. 6, the step S120 further comprises the following steps S121-S122.

S121: Calculating an angle deviation of the yaw axis gimbal angle parameter from the predetermined angle parameter and a distance deviation of the distance parameter from a first predetermined distance.

In this disclosure, the gimbal camera and the photographing-moving apparatus keep still relative to each other in order to obtain a better shooting and tracking effect, and photographing-moving apparatus provided for placing the gimbal camera always keep facing the target, so that the predetermined angle parameter is set to 0°, and the angle deviation of the yaw axis gimbal angle parameter from the predetermined angle parameter is the difference between the actual sampled value (the angle of lens relative to the positive direction, which is the difference between the angle of the yaw axis of the three-axis gimbal relative to the positive direction) and the predetermined angle value; and the distance deviation is the difference between the actual distance value and a first predetermined distance. In this step, the first predetermined distance is set to 2 m, but it can also be set according to actual needs in some other embodiments.

Understandably, this embodiment can calculate the distance change rate according to the distances obtained in different time intervals, wherein the distance change rate is directly proportional to the heading speed of the target. In other words, the quicker the forward movement of the target, the larger the distance change rate. Therefore, the motor of the photographing-moving apparatus needs a higher speed per unit time to catch up with the target. The greater the acceleration of the target, the greater the acceleration is the robotic car, so that the robotic car starts and stops more steeply, whereas the smaller the acceleration of the target, the smaller the acceleration of the robotic car, so that the robotic car starts and stops smoother. By obtaining the distance change rate, the movement of the photographing-moving apparatus may be controlled more precisely.

S122: Calculating a steering gear rotation angle control parameter and a motor speed control parameter according to the angle deviation and the distance deviation respectively by using the PID algorithm.

In this step, the PID algorithm is used for calculating and obtaining the steering gear rotation angle control parameter according to the angle deviation, while calculating and obtaining the motor speed control parameter according to distance deviation, the equation of the Proportion-Integral-Differential (PID) algorithm is u=Kₚ×error+Kᵢ×∫error+K_{d}×d(error)/dt, where error is the above obtained angle deviation, Kₚ, Kᵢ, and K_{d} are the coefficients of the proportional term, the integral term, the differential term in the PID algorithm respectively, which are all constants. In this step, u is the steering gear rotation angle control parameter or the motor speed control parameter.

S130: Controlling the rotation of a gimbal of a gimbal camera according to the yaw axis gimbal angle parameter to further control the rotation of the camera, controlling the rotation of a steering gear installed in a photographing-moving apparatus for placing the gimbal camera according to the steering gear rotation angle control parameter, so that the photographing-moving apparatus faces a target, while controlling the rotation speed of a motor installed in the photographing-moving apparatus according to motor speed control parameter to achieve tracking the target.

Specifically, controlling the rotation of the gimbal of the gimbal camera according to the yaw axis gimbal angle parameter to control the rotation of the camera comprises: calculating an angle deviation of the yaw axis gimbal angle parameter from the predetermined angle parameter; controlling the rotation of the gimbal of the gimbal camera according to the angle deviation in order to control the rotation of the camera. In this disclosure, the shooting angle of the camera is adjusted according to the angle deviation, so that the lens of the camera faces the target to ensure that the target always stays within the range of the camera.

In this embodiment, based on the difference between the yaw axis gimbal angle parameter and the predetermined angle parameter, namely the difference between the rotation angle of the gimbal camera and the predetermined angle parameter, and the difference of the distance between the camera and the target and the predetermined distance, the steering control of the yaw axis of the steering gear and the motor speed control can be carried out by using the PID algorithm, so as to achieve both distance control and direction control simultaneously, thereby following the tracked target when the target is moving freely. In other words, when the target is moving sideways, the yaw axis of the three-axis gimbal of the gimbal camera will rotate towards the moving direction of the target so as to drive and rotate the camera, and the steering gear of the robotic car is fine-tuned in the same direction of the camera until the steering of the camera reverts to its original position, and the front of the car always tends to face the target to ensure a proper tracking direction, while the robotic car and the target are kept at a specific distance from each other to ensure a proper tracking distance.

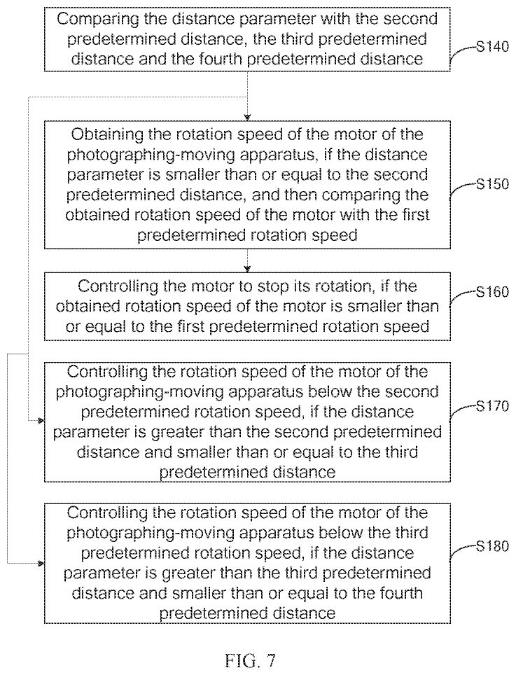

Referring to FIG. 7 for a flowchart of a method for automatically tracking and photographing in accordance with another embodiment of this disclosure, additional steps S140-S180 are added on the basis of the above-mentioned method for automatically tracking and photographing to the previous embodiment as described in FIG. 1, and are described in details below.

S140: Comparing the distance parameter with the second predetermined distance, the third predetermined distance and the fourth predetermined distance. If the distance parameter is smaller than or equal to the second predetermined distance, then the steps S150-S160 is carried out; if the distance parameter is greater than the second predetermined distance and smaller than or equal to the third predetermined distance, then the step S170 is carried out; and if the distance parameter is greater than the third predetermined distance and smaller than or equal to the fourth predetermined distance, then the step S180 is carried out.

Understandably, a maximum speed is set with different levels according to different distances between the camera and the target in this embodiment, in order to avoid the robotic car from keeping moving when the target suddenly stops during the moving process. In other words, if the distance parameter falls within a certain distance interval, the maximum rotation speed is the maximum speed limit corresponding to the current distance interval, so as to prevent the robotic car from being too close to the target or colliding with the target in a sudden stop due to the insufficient braking distance.

In this disclosure, if the distance parameter is greater than the fourth predetermined distance, the robotic car will not collide with the target due to insufficient braking distance, and there is no corresponding maximum speed limit set. In other words, if the distance between the target and the camera is greater than the fourth predetermined distance, the maximum speed of this distance interval will not be limited. Understandably, the robotic car has an overall maximum speed due to its internal hardware limitation. If the distance parameter is greater than the fourth predetermined distance, although no maximum speed corresponding to this distance interval class is set, the speed still cannot exceed the overall maximum speed of the robotic car.

S150: Obtaining the rotation speed of the motor of the photographing-moving apparatus motor, and comparing the obtained rotation speed of the motor with a first predetermined rotation speed.

If the obtained distance between the camera and the target is smaller than or equal to a second predetermined distance in this step, then the rotation speed of the motor of the photographing-moving is obtained and compared with the first predetermined rotation speed.

S160: Controlling the motor to stop rotating, if the rotation speed of the motor obtained is smaller than or equal to the first predetermined rotation speed.

If the distance between the camera and the target is smaller than a predetermined distance, the very small difference of the integral effect in the PID modulator will be amplified gradually with time, so that the robotic car moves forward and backward repeatedly, fluctuating around this predetermined distance. In this embodiment, a certain control window is set to realize the safe and reliable start and stop of the robotic car as described in the steps S150-S160 above. In other words, when the distance between the camera and the target is smaller than or equal to the second predetermined distance (such as 1 m), the current speed of the robotic car is detected. If the detected speed of the robotic car is very slow (that is, the rotation speed of the motor of the robotic car is smaller than or equal to the first predetermined rotation speed), the speed of the robotic car is set to 0, and if the robotic car stops at a position within the range of the predetermined distance, the robotic car will remain still to reach a stably stopped status.

S170: Controlling the rotation speed of the motor of the photographing-moving apparatus motor to be not greater than a second predetermined rotation speed.

In this step, when the distance parameter, namely the distance between the camera and the target, is between the second predetermined distance and the third predetermined distance, the maximum rotation speed of the motor of the robotic car is set to be the second predetermined rotation speed.

S180: Controlling the rotation speed of the photographing-moving apparatus motor to be not greater than a third predetermined rotation speed.

In this step, when the distance between the camera and the target falls within a range between the third predetermined distance and the fourth predetermined distance, the maximum rotation speed of the motor of the robotic car is set to be the third predetermined rotation speed. The second predetermined rotation speed is smaller than the third predetermined rotation speed.

In summary, this disclosure uses the photographing-moving apparatus to carry the gimbal camera. The gimbal camera obtains the yaw axis gimbal angle parameter and processes the image captured by the camera to obtain the distance parameter, controls the rotation of the gimbal according to the yaw axis gimbal angle parameter to adjust the rotation angle of the camera, calculates a steering gear rotation angle control parameter and a motor speed control parameter according to the yaw axis gimbal angle parameter and the distance parameter, and controls the rotation speed of the motor of the photographing-moving apparatus motor according to the motor speed control parameter to achieve distance tracking, while controlling the steering of the steering gear installed in the photographing-moving apparatus according to the steering gear rotation angle control parameter, so that the rotation angle of the steering gear is the same as the rotation angle of the camera, and the photographing-moving apparatus always faces the target to achieve direction tracking. In this disclosure, the rotation angle of the camera is adjusted to ensure the shooting effect of the tracked target, while the photographing-moving apparatus carries out the distance tracking and the direction tracking simultaneously to keep tracking and following the moving target.

It is noteworthy that the description of each of the aforementioned embodiments has its own emphasis, and for the parts that are not described in details in a certain embodiment, we can refer to the related descriptions of other embodiments. For simplicity the description of each embodiment is expressed as a series of action combinations, but those skilled in the art should be aware that this disclosure is not limited by the sequence of actions so described, because some steps can be performed in other sequences or at the same time according to this disclosure. Those skilled in the art should also be aware of the embodiment described in the specification is a preferred embodiment, and the actions and modules involved are not necessarily required by this disclosure. While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for automatically tracking and photographing, comprising:
obtaining a yaw axis gimbal angle parameter, and processing an image captured by a camera to obtain a distance parameter,
calculating a steering gear rotation angle control parameter according to the yaw axis gimbal angle parameter, and calculating a motor speed control parameter according to the distance parameter;
controlling rotation of a gimbal of a gimbal camera according to the yaw axis gimbal angle parameter to further control rotation of the camera, and controlling rotation of a steering gear installed in a photographing-moving apparatus for placing the gimbal camera according to the steering gear rotation angle control parameter, so that the photographing-moving apparatus faces a target, while controlling a rotation speed of a motor installed in the photographing-moving apparatus according to motor speed control parameter to achieve target tracking,
wherein the method further comprising following steps after processing the image captured by the camera to obtain the distance parameter:
comparing the distance parameter with a second predetermined distance;
obtaining the rotation speed of the motor of the photographing-moving apparatus, if the distance parameter is smaller than or equal to the second predetermined distance;
comparing the rotation speed of the motor with the first predetermined rotation speed; and
controlling the motor to stop rotating, if the rotation speed of the motor obtained is smaller than or equal to the first predetermined rotation speed.

2. The method for automatically tracking and photographing according to claim 1, wherein calculating the steering gear rotation angle control parameter according to the yaw axis gimbal angle parameter comprises:
calculating an angle deviation of the yaw axis gimbal angle parameter from a predetermined angle parameter; and
using a PID algorithm to calculate the steering gear rotation angle control parameter according to the angle deviation to control the rotation of the steering gear of the photographing-moving apparatus, so that the photographing-moving apparatus faces the target.

3. The method for automatically tracking and photographing according to claim 1, wherein calculating the motor speed control parameter according to the distance parameter comprises:
calculating a distance deviation of the distance parameter from a first predetermined distance; and
using a PID algorithm to calculate the motor speed control parameter according to the distance deviation.

4. The method for automatically tracking and photographing according to claim 1, further comprising following steps after the distance parameter is compared with the second predetermined distance:
comparing the distance parameter with a third predetermined distance and a fourth predetermined distance;
controlling the rotation speed of the motor of the photographing-moving apparatus so that the rotation speed is not greater than a second predetermined rotation speed, if the distance parameter is greater than the second predetermined distance and smaller than or equal to the third predetermined distance; and
controlling the rotation speed of the motor of the photographing-moving apparatus so that the rotation speed is not greater than a third predetermined rotation speed if the distance parameter is greater than the third predetermined distance and smaller than or equal to the fourth predetermined distance;
wherein, the second predetermined rotation speed is smaller than the third predetermined rotation speed.

5. The method for automatically tracking and photographing according to claim 1, wherein controlling the rotation of the gimbal of the gimbal camera according to the yaw axis gimbal angle parameter in order to control the rotation of the camera comprises:
calculating an angle deviation of the yaw axis gimbal angle parameter from a predetermined angle parameter; and
controlling the rotation of the gimbal of the gimbal camera according to the angle deviation in order to control rotation of the camera.

6. A system for automatically tracking and photographing, comprising:
a gimbal camera, having a gimbal, a camera and a controller installed on the gimbal, the gimbal being used for adjusting a rotation angle of the camera; and
a photographing-moving apparatus for placing the gimbal camera, and the photographing-moving apparatus being provided with a steering gear for controlling a heading direction of the photographing-moving apparatus, and a motor for controlling an operating speed of the photographing-moving apparatus;
wherein the controller comprises:
a first acquiring unit, for obtaining a yaw axis gimbal angle parameter, and processing an image captured by the camera to obtain a distance parameter;
a processing unit, for calculating a steering gear rotation angle control parameter according to the yaw axis gimbal angle parameter, and calculating a motor speed control parameter according to the distance parameter;
a control adjusting unit, for controlling rotation of the gimbal of the gimbal camera according to the yaw axis gimbal angle parameter in order to control rotation of the camera, and controlling rotation of a steering gear installed in the photographing-moving apparatus according to the steering gear rotation angle control parameter, so that the photographing-moving apparatus faces a target, while controlling a rotation speed of the motor installed in the photographing-moving apparatus according to the motor speed control parameter, so as to realize target tracking;
a first comparison unit, for comparing the distance parameter with a second predetermined distance;
a second acquiring unit, obtaining the rotation speed of the motor of the photographing-moving apparatus if the distance parameter is smaller than or equal to the second predetermined distance; and
a second comparison unit, for comparing the rotation speed of the motor obtained with a first predetermined rotation speed;
wherein the control adjusting unit is further used for controlling the motor to stop rotating, if the rotation speed of the motor obtained is smaller than or equal to the first predetermined rotation speed.

7. The system for automatically tracking and photographing according to claim 6, wherein the processing unit comprises:
a first calculation unit, for calculating an angle deviation of the yaw axis gimbal angle parameter from a predetermined angle parameter, the predetermined angle parameter being 0°;
a first PID control unit, for calculating a steering gear rotation angle control parameter according to the angle deviation by using a PID algorithm;
a second calculation unit, for calculating a distance deviation of the distance parameter from a first predetermined distance; and
a second PID control unit, for calculating a motor speed control parameter according to the distance deviation by using the PID algorithm.

8. The system for automatically tracking and photographing according to claim 6, wherein the controller further comprises:
a third comparison unit, for comparing the distance parameter with the second predetermined distance, the third predetermined distance and the fourth predetermined distance;
wherein the control adjusting unit is provided for controlling the rotation speed of the motor of the photographing-moving apparatus so that the rotation speed is not greater than the second predetermined rotation speed if the distance parameter is greater than the second predetermined distance and smaller than or equal to the third predetermined distance, and controlling the rotation speed of the motor of the photographing-moving apparatus so that the rotation speed is not greater than the third predetermined rotation speed if the distance parameter is greater than the third predetermined distance and smaller than or equal to the fourth predetermined distance, and the second predetermined rotation speed is smaller than the third predetermined rotation speed.
